(19) United States
(12) Patent Application Publication
(10) Pub. No.: US 2018/0280934 A1
(43) Pub. Date: Oct. 4, 2018

(54) HETEROGENEOUS CORE@SHELL PHOTOCATALYST, MANUFACTURING METHOD THEREFORE AND ARTICLES COMPRISING PHOTOCATALYST

(71) Applicant: The Board of Regents of The University of Texas System, Austin, TX (US)

(72) Inventor: Yuanbing Mao, Edinburg, TX (US)

(21) Appl. No.: 15/524,418

(22) PCT Filed: Nov. 3, 2015
(86) PCT No.: PCT/US15/58786

§ 371 Date: May 4, 2017

Related U.S. Application Data
(60) Provisional application No. 62/074,835, filed on Nov. 4, 2014.

(51) Int. Cl. B01J 21/18; B01J 21/06; B01J 23/02; B01J 35/00; B01J 37/02; B01J 35/02; C02F 1/28; C02F 1/32; C02F 1/72

(52) U.S. Cl. CPC B01J 21/18; B01J 21/063; B01J 23/02; B01J 35/004; B01J 37/0221; C02F 2305/10; C02F 1/288; C02F 1/32; C02F 1/725; C02F 1/283; C02F 1/281; B01J 35/023

(57) ABSTRACT

A heterogeneous core@shell photocatalyst having a combination of properties that include rapid adsorption and effective decomposition with respect to various substances is provided. This core@shell photocatalyst comprises a conventional photocatalyst core coated with an adsorbent surface layer (in the nanometer size range). The novel heterogeneous photocatalyst can be formed by a simple hydrothermal method.

### BACKGROUND OF THE INVENTION

### 1. Field of the Invention

The invention generally relates to photocatalysts. More particularly, the invention relates to photocatalysts having a core@shell structure.

### 2. Description of the Relevant Art

The health and welfare of people, especially of vulnerable groups such as children, the elderly and poor, are closely connected to the availability of adequate, safe and affordable water supplies. Water quality in a wide variety of industrial, municipal and agricultural sources has been seriously tainted due to increasing pollution of ground and surface water from these sources, severely reducing the supply of freshwater for human use. There are about 1 billion people in the world whom have no access to potable water and a further 2.6 billion people lack access to adequate sanitation. Hence, there is a clear need for the development of innovative technologies and new materials whereby challenges associated with the provision of safe portable water can be addressed.

Conventional photocatalysts, such as transition metal oxides and transition metal sulfides, are capable of decomposing and removing contaminants and microorganisms from polluted water photocatalytically. However, the low adsorption capacity of most conventional photocatalysts is a barrier to hinder their practical applications.

Adsorbents can also be used to remove pollutants and microorganisms from water. However, since the adsorbent is capable of only adsorption rather than decomposition, the adsorbent will become saturated over time. The adsorption capability weakens even if common regeneration processes are used to regenerate the adsorbent.

The low cost and high photodecontamination activity of transition metal oxides and sulfides toward water borne contaminants and microorganisms from polluted water make these materials attractive for the production of low cost, effective and efficient water purification systems when combined with low cost and highly adsorptive adsorbents. It is therefore desirable to develop transition metal oxide or sulfide based purification systems that maximize the features of low cost, high decontamination efficiency, fast decontamination process, and reusability.

### SUMMARY OF THE INVENTION

In an embodiment, a photocatalyst particle includes a transition metal oxide or transition metal sulfide core; and an adsorbent layer at least partially surrounding the transition metal oxide core. The adsorbent layer is capable of adsorbing pollutants and microorganisms in a wastewater stream. In some embodiments, the adsorbent layer is a carbonaceous coating layer. The adsorbent layer, in some embodiments, has a thickness of less than 1 micron.

In one embodiment, the core is a transition metal oxide. In other embodiments, the core is a transition metal sulfide. The transition metal of the core is selected from the group consisting of Ti, W, Fe, Zn, Cd, and Sn. Specific examples of a material used as the core are titanium dioxide and strontium titanate.

The above described photocatalyst particle can be used in a pollutant and microorganism decomposition process that can be conducted at room temperature and atmospheric pressure. The described photocatalyst particle exhibit a decomposition efficiency of greater than about 90%, a decontamination rate of less than about 30 min, and reusability of more than 10 times.

A method of making a photocatalyst particle, includes obtaining a core particle, the core particle comprising a transition metal oxide or transition metal sulfide; and forming a carbonaceous coating on the core particle. In some embodiments, the core particle has a diameter of less than about 1 micron. The carbonaceous coating may have a thickness of less than about 1 micron.

The process of forming a carbonaceous coating on the core particle includes, in one embodiment, placing uncoated core particles in water and coating the core particle with a carbonaceous layer at a temperature of less than 200° C. and greater than 100° C. In an exemplary process, the carbonaceous coating is formed at a temperature greater than 100° C. and a pressure of greater than 1 atm.

In an embodiment, a method of decontaminating a polluted wastewater stream includes: contacting the wastewater stream with a photocatalyst particle, as described above, for a time sufficient to remove or destroy at least about 90% of the contaminants in the wastewater stream.

### BRIEF DESCRIPTION OF THE DRAWINGS

Advantages of the present invention will become apparent to those skilled in the art with the benefit of the following detailed description of embodiments and upon reference to the accompanying drawings in which:

FIG. 1 depicts a schematic diagram of a TiO₂@C core/shell photocatalyst particle;

FIG. 2 depicts XRD analysis of uncoated and coated titanium dioxide nanoparticles;

FIG. 3 depicts Raman analysis of coated and uncoated TiO₂ particles;

FIG. 4 depicts the change in dye concentration vs. time for uncoated and various coated TiO₂ particles;

FIG. 5 depicts the slopes of the change in dye concentration for uncoated and various coated TiO2 particles vs. the concentration of glucose present;

FIG. 6A depicts the 1^{st} order kinetics linear regression of uncoated TiO₂;

FIG. 6B depicts the 2^{nd} order kinetics linear regression of uncoated TiO₂;

FIG. 7A depicts the 1^{st} order kinetics linear regression of TiO₂ coated with 3 mg of glucose;

FIG. 7B depicts the 2^{nd} order kinetics linear regression of TiO₂ coated with 3 mg of glucose;

FIG. 8 depicts the effect of the concentration of methylene blue on the adsorption of the catalyst;

FIG. 9A depicts a plot of uncoated TiO₂ in the linear form of the Langmuir isotherms;

FIG. 9B depicts a plot of TiO₂ coated with 3 mg of glucose in the linear form of the Langmuir isotherms;

FIG. 9C depicts a plot of uncoated TiO₂ in the linear form of the Freundlich isotherms;

FIG. 9D depicts a plot of TiO₂ coated with 3 mg of glucose in the linear form of the Freundlich isotherms;

FIG. 10 depicts the cyclability of the TiO₂ coated with 3 mg of glucose; and

FIG. 11 depicts the effect of photocatalytic temperature on the degradation process of MB.

While the invention may be susceptible to various modifications and alternative forms, specific embodiments thereof are shown by way of example in the drawings and will herein be described in detail. The drawings may not be to scale. It should be understood, however, that the drawings and detailed description thereto are not intended to limit the invention to the particular form disclosed, but to the contrary, the intention is to cover all modifications, equivalents, and alternatives falling within the spirit and scope of the present invention as defined by the appended claims.

### DETAILED DESCRIPTION OF THE PREFERRED EMBODIMENTS

It is to be understood the present invention is not limited to particular devices or methods, which may, of course, vary. It is also to be understood that the terminology used herein is for the purpose of describing particular embodiments only, and is not intended to be limiting. As used in this specification and the appended claims, the singular forms “a”, “an”, and “the” include singular and plural referents unless the content clearly dictates otherwise. Furthermore, the word “may” is used throughout this application in a permissive sense (i.e., having the potential to, being able to), not in a mandatory sense (i.e., must). The term “include,” and derivations thereof, mean “including, but not limited to.” The term “coupled” means directly or indirectly connected.

In an embodiment, a heterogeneous core@shell photocatalyst particle includes a transition metal oxide or transition metal sulfide core; and an adsorbent layer at least partially surrounding the transition metal oxide or sulfide core. The adsorbent layer is capable of adsorbing pollutants and microorganisms in a wastewater stream. In some embodiments, the adsorbent layer is a carbonaceous coating layer. The adsorbent layer, in some embodiments, has a thickness of less than 1 micron.

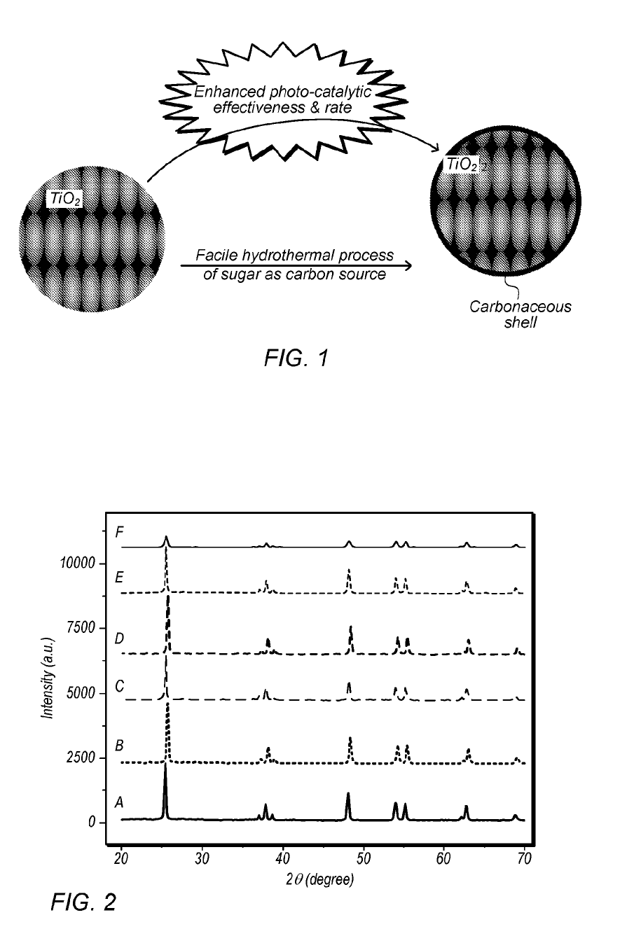

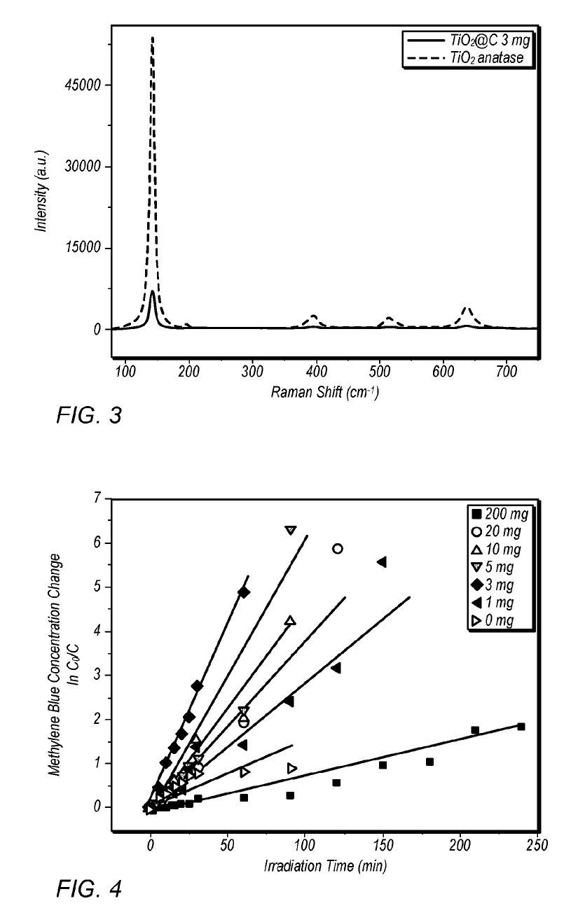

The described heterogeneous core@shell photocatalyst particles simultaneously enhance photocatalytic decontamination efficiency and rate by coupling the functionalities of photocatalyst core nanoparticles and nanostructured shell coatings. A schematic diagram of an exemplary photocatalyst particle is shown in FIG. 1. The described photocatalyst particles are based on the combination of these two nanostructured components based on materials selection and synthesis parameters. These, in turn, dictate the photocatalytic efficiency and rate. Moreover, they are reusable with more than ten cycles, even if the adsorption process and photocatalytic decontamination process are employed separately.

In one embodiment, the core is a transition metal oxide. In other embodiments, the core is a transition metal sulfide. While any transition metal oxide/sulfide may be used, particularly useful transition metals oxide/sulfides include, but are not limited to, oxides and sulfides of Ti, W, Fe, Zn, Cd, Sr, and Sn. Specific examples of transition metal oxide/sulfides include, but are not limited to, TiO₂, SrTiO₃, WO₃, Fe₂O₃, ZnO, CdS, ZnS, and SnO₂.

In a specific embodiment, the core component is titanium dioxide (or strontium titanate), well-known and widely used photocatalysts, in a nanoparticle form. In a typical photocatalytic reaction, photogenerating electrons and holes are captured by O₂ and H₂O absorbed by TiO₂ (or SrTiO₃) forming superactive .OH, .O²⁻ and .OOH oxidants which decompose pollutants and microorganisms. However, the low adsorption capacity of TiO₂ (or SrTiO₃) is a barrier to hinder its practical application. For example, due to the lack of adsorption action to attract pollutants and microorganisms, TiO₂ (or SrTiO₃) can only decompose substances that happened to come into contact with it. The second component, carbonaceous layer as the shell, is used as adsorbent sites for pollutants and microorganisms. However, since the carbonaceous layer is capable of only adsorption rather than decomposition, saturation will be reached over time, and its adsorption capability weakens as well.

In the designed exemplary TiO₂@C (or SrTiO₃@C) core/shell nanostructured photocatalyst, the carbonaceous shell provides a large amount of hydroxyl and C—O functional groups, which can increase the trapping sites for pollutants and microorganisms, resulting in closer reach and stronger attachment with not only photogenerated holes, but also photogenerated electrons to enhance the photocatalytic reaction in terms of both efficiency and rate. As a result, these novel photocatalysts show higher photocatalytic activity and rate than the unmodified TiO₂ (or SrTiO₃) photocatalyst (see FIG. 1).

A method of making a photocatalyst particle, includes obtaining a core particle, the core particle comprising a transition metal oxide or transition metal sulfide; and forming a carbonaceous coating on the core particle. In some embodiments, the core particle has a diameter of less than about 1 micron. The carbonaceous coating may have a thickness of less than about 1 micron.

The process of forming a carbonaceous coating on the core particle includes, in one embodiment, placing uncoated core particles in water and reacting the core particle with a carbohydrate at a temperature of less than 200° C. and greater than 100° C. In an exemplary process, the carbonaceous coating is formed at a temperature greater than 100° C. and a pressure of greater than 1 atm.

As used herein a carbohydrate is molecule consisting of carbon (C), hydrogen (H), and oxygen (O) atoms, usually with a hydrogen:oxygen atom ratio of 2:1. Exemplary carbohydrates that may be used in the process of forming a carbonaceous adsorbent layer include, but are not limited to, glucose, galactose, fructose, sucrose, and lactose.

The use of a photocatalyst according to the prior art does not always lead to complete toxic contaminant molecules decomposition nor with a rapid mineralization rate. For example, known photocatalysts containing TiO₂ (or SrTiO₃) usually takes more than four hours to decompose 90% of toxic contaminant molecules. Other transition metal oxides/sulfides based composite photocatalysts show fast decomposition performance, but are made through tedious and costly synthetic routes with non-cost effective materials.

The heterogeneous core@shell photocatalysts described herein (using, for example, TiO₂ (or SrTiO₃) based catalyst and carbon-based adsorbent have several advantages: (i) both TiO₂ (or SrTiO₃) and carbon are relatively low cost, (ii) the shell coating process on TiO₂ (or SrTiO₃) core is very facile and cost-effective, using only a carbohydrate as the carbonaceous source under mild and neutral hydrothermal process for a couple of hours, (iii) no high temperature annealing process under inert atmosphere is needed to convert the carbon source into carbon-based adsorbent as in the prior art, (iv) the photocatalytic decomposition process can be conducted at room temperature and atmospheric pressure; (v) the resulting heterogeneous core@shell photocatalysts show surprisingly high decomposition efficiency (˜100%), rapid decontamination rate (<30 min), and great cyclability (>10 cycles).

In an embodiment, a method of decontaminating a polluted wastewater stream includes: contacting the wastewater stream with a heterogeneous core@shell photocatalyst particle, as described above, for a time sufficient to remove or destroy at least about 90% of the contaminants in the wastewater stream. The above described heterogeneous core@shell photocatalyst particle can be used in a pollutant decomposition process that can be conducted at room temperature and atmospheric pressure. The described heterogeneous core@shell photocatalyst particle exhibit a decomposition efficiency of greater than about 90%, a decontamination rate of less than about 30 min, and great cyclability (>10 cycles).

The following examples are included to demonstrate preferred embodiments of the invention. It should be appreciated by those of skill in the art that the techniques disclosed in the examples which follow represent techniques discovered by the inventor to function well in the practice of the invention, and thus can be considered to constitute preferred modes for its practice. However, those of skill in the art should, in light of the present disclosure, appreciate that many changes can be made in the specific embodiments which are disclosed and still obtain a like or similar result without departing from the spirit and scope of the invention.

Process of Forming a TiO₂@C (or SrTiO₃@C) Core/Shell Photocatalyst

Commercially available TiO₂ anatase with a purity of the 99% and a particle size ranging from 100-250 nm was used as the main reagent. Six different synthesis were performed using the same quantity of TiO₂ but differing in the amount of glucose—200, 20, 10, 5, 3 and 1 mg. 750 mg of TiO₂ nanoparticles were dissolved in 18 mL of twice deionized water inside of a 23 mL autoclave and the dissolution was left to stir for 30 minutes. After this lapse of time different quantities of glucose were added to the titanium dioxide and the stirring process continued for around 30 more minutes. The vessel was sealed in a steel autoclave and taken to an oven for a hydrothermal process at a temperature of 160° C. for 8 hours. The resulting product was washed with 100 mL of deionized water and centrifuged in a centrifuge 2 times at 600 rpm for a period of 10 minutes, subsequently after the removal of any possible unreacted precursors, the resulting compound was taken to dry in an oven at a temperature of 80° C. for 8 hours.

### Characterization

The resulting samples were characterized through X-Ray diffraction (XRD) from a 20 range of 20 to 70°. Scanning electron microscopy (SEM) was used to analyze the morphology of the TiO₂ before and after the carbon coating. Other characterization used to determine the presence of the carbon in the core/shell sample include Raman and Infrared spectroscopies.

### Photocatalytic Degradation

Methylene blue (C₁₆H₁₈ClN₃S.3H₂O) was used as the model organic contaminant. The pH of the methylene blue solution for the photocatalytic test was 7.4 and the concentration used for the different photocatalytic samples was 10 ppm. The solution was left to stir for five minutes until the color was uniform, then 50 mL of the methylene blue solution was transferred into a quartz container and subsequently TiO₂ was added to the solution. The compound was left to absorb the methylene blue (MB) for a period of 30 minutes. Measurements were taken every 5 minutes to analyze of the progress of the degradation portion. This part of the experiment was carried in a dark environment so that the light from the room or any other source would not affect premature activation of the product and inadvertently start degradation of methylene blue.

After the first 30 minutes, a UV lamp was positioned on the top of the quartz glass at an approximate distance of 5 cm and the UV lamp was tuned to a wavelength of 365 nm. The degree of degradation was measured with a JENWAY 63200 spectrophotometer at a wavelength of 668 nm and the measurements were made relative to water as the blank. Photocatalytic experiments were performed during a time period of 2 hours and the results were based on the data collected during that lapse of time.

### Adsorption Kinetics and Equilibrium Study

From the change in dye concentration vs. time for uncoated and various coated TiO₂ particles, titanium dioxide coated with 3 mg of glucose possesses the best adsorption capability. Therefore, titanium oxide coated with 3 mg of glucose was analyzed in solutions of methylene blue (MB) with different concentrations (1, 3, 5, 7, 11, 13 and 16 ppm) in order to reveal its behavior and, after its analysis, it was compared to those results given by uncoated TiO₂ anatase nanoparticles.

Samples were taken every 5 minutes for the first 30 minutes and after that they were taken with longer intervals of time. The samples were centrifuged and analyzed by a spectrophotometer to get the absorbance that was transformed into mg of methylene blue adsorbed by grams of catalyst (TiO₂@3 mg) that is represented as (qt). The following equations were used to determine if the kinetic behavior of the product was first or second order (See Ding et al. “Adsorption of cesium from aqueous solution using agricultural residue e Walnut shell: Equilibrium, kinetic and thermodynamic modeling studies.” Water Research (2013). Volume (47). 2563-2571, which is incorporated herein by reference, for more details).

### Linear Pseudo 1st Order Kinetic Model:

$$ln ( {q}_{e} - {q}_{t} ) = ln ( {q}_{e} ) - \frac{{K}_{1}}{2 \text{,} 303} t \qquad ( 1 )$$

### Linear Pseudo 2nd Order Kinetic Model:

$${q}_{t} = \frac{{{K}_{2} ( {q}_{e} )}_{⋀ 2} t}{1 + {K}_{2 {q}_{e}} t} \qquad ( 2 )$$

In these equations qₑ and qₜ (mg g⁻¹) symbolize the amount of MB adsorbed at equilibrium and at any given time, and K₁ (min⁻¹) and K₂ (g mg⁻¹ min⁻¹) are just constants or also called adsorption constants.

For the analysis, (qₜ) was compared to its correlation (R²) with the linear model to determine for 1st or 2nd behavior. The equilibrium analysis involved the linear forms of Langmuir and Freundlich isotherms that determine if the adsorption of the MB is monolayer (Langmuir) or multilayer (Freundlich). The analysis was possible by graphing the qₑ values obtained in the different concentrations tests and correlating them to the (R²).

### Non-Linear Formula for Langmuir Model:

$${q}_{e} = \frac{{q}_{m} KC}{1 + KC} \qquad ( 3 )$$

### Non-Linear Formula for Freundlich Model:

qₑ=k_{f}Cⁿ (4)

### Linear Form for Langmuir Model:

$$\frac{1}{{q}_{e}} = \frac{1}{{Kq}_{m}} \cdot \frac{1}{C} \cdot \frac{1}{{q}_{m}} \qquad ( 5 )$$

### Linear Form for Freundlich Model:

ln qₑ=n ln C+ln k_{f} (6)

Where qₘ (mg g⁻¹) is the adsorption capacity at the isotherm temperature; K (L mg⁻¹) is a constant related to the free energy or net enthalpy of adsorption; C (μmol) represent the different concentrations used for the analysis (3, 5, 7, 11, and 13 ppm); k_{f} and n are equilibrium constants indicative of adsorption capacity and adsorption intensity respectively.

### Reproducibility Analysis

A reproducibility test was performed by using 0.075 grams of titanium dioxide nanoparticle coated with three milligrams of glucose in a 50 mL solution of methylene blue with a concentration of 10 ppm. The test was carried out until no further degradation was observed, depending on the cycle's efficiency; the remaining clean solution was centrifuged to collect the nanoparticles. Once the particles were separated from the supernatant by pipetting the water out, they were dried and stored for the next analysis. 50 mL more of the contaminated water was added to the dried particles and this process was repeated until the degradation abilities of the particles were lost, which also comes from the loss of the photocatalyst particles during the cycling test.

### Thermodynamic Analysis of the Degradation and Adsorption Processes

The degradation analysis was followed exactly as mentioned above. The only variant was the temperature. The temperatures selected for the analysis were 25° C., 33° C., 40° C., 60° C., and 80° C. The measurements were carried on until the absorbance reported was zero; subsequently the resulting data was fitted into linear representation of the relationship of concentration over time. The linear forms of the degradation reactions were adopted to distinguish visually which temperature was the best to perform the process.

The thermodynamic properties of the TiO₂@C nanoparticles at equilibrium with the methylene blue were determined through the acquisition of absorbance points for a total of 3 hours at the previously presented temperatures. The data was collected every 5 minutes until the time completion and the analysis was carried out under absolute darkness. From the data the following series of equations were used to determine the equilibrium constant, the Gibbs free energy, the enthalpy of the reaction and the entropy involved.

$$\begin{matrix}Equilibrium constant \text{:} \\ K = \frac{{C}_{0} - {C}_{E}}{{C}_{E}} & ( 7 ) \\ Gibbs free energy \text{:} \\ Δ G = - RTlnK & ( 8 ) \\ Enthalpy \text{:} \\ ( \frac{\partial \frac{1}{K}}{\partial \frac{1}{T}} ) = - \frac{Δ H}{R} & ( 9 ) \\ Entropy \text{:} \\ Δ S = ( \frac{Δ G - Δ H}{T} ) - 1 & ( 10 )\end{matrix}$$

In equation (7) K is the equilibrium constant, Cₒ is the initial concentration of the methylene blue when it was in contact with the carbon treated TiO₂ nanoparticles and C_{E} is the concentration at equilibrium in which the absorbance numbers were constant and no further change was observed. In equation (8) ΔG is the Gibbs free energy, R is the gas constant, T is the temperatures in Kelvins at which the trials were performed and ln K is the natural logarithm of the equilibrium constant of the system. The variables used for equations (7) and (8) are the same as the ones found in equations (9) and (10) with the difference of the state variables ΔH and ΔS which represent enthalpy and entropy in that order.
Characterization of Titanium Dioxide Coated with Carbon

The six samples (glucose—200, 20, 10, 5, 3 and 1 mg) were examined by XRD in order to analyze the structure of the titanium dioxide nanoparticles; the study showed an identical pattern as those provided by other investigations, there 4 distinctive peaks that are characteristic of the anatase phase which revealed a perfect crystalline structure and since the carbon coating produced from the glucose is amorphous there was not pattern change shown in the XRD. From the analysis it can be concluded that the sample has purity and kept its crystalline lattice. In FIG. 2, the patterns of the six samples were plotted in conjunction with the pattern of the TiO₂ anatase for comparison.

The SEM images were taken to analyze the morphology of the samples. Coating with different percentages of carbon rounded the corners of the original TiO₂. This morphological change is most noticeable in the samples containing a greater amount of glucose percentage.

Similarly, Raman spectra from both unmodified TiO₂ and glucose treated TiO₂ particles are identical, indicating no change was introduced by the carbonaceous coating.

### Photocatalytic Degradation of Methylene Blue

Samples of TiO₂ reflected a distinctive range of degradation of the contaminant as the carbon coating present increased or decreased. Table 1 depicts the quantity of carbon and the degradation of the methylene blue in a period of 2 hours. The 2 hours were chosen to be the base time for the measurements because the period of degradation ranged from 120 minutes to more than 240 minutes but ideally the better compounds completed the degradation of methylene blue in two hours (120 minutes) or less.

TABLE 1
Photocatalytic degradation of methylene blue by both
unmodified TiO₂ and glucose treated TiO₂ particles

| | Coatings of | | MB degradation | Complete |
|---|---|---|---|---|
| | glucose | | by UV in 2 hrs | degradation |
| Samples | (mg) | | (%) | (min) |
| TiO₂ anatase | 0.00 | mg | 43.8 | 240> |
| Sample 1 | 200 | mg | 43.8 | 240 |
| Sample 2 | 20.0 | mg | 99.7 | 120 |
| Sample 3 | 10.0 | mg | 100 | 120 |
| Sample 4 | 5.00 | mg | 100 | 90.0 |
| Sample 5 | 3.00 | mg | 100 | 60.0 |
| Sample 6 | 1.00 | mg | 95.8 | 150 |

Sample 5 which contained 3 mg of glucose was the most successful in a rapid degradation of the dye compared to other samples including the pure TiO₂ anatase. The organic functional groups present on the surface of the TiO₂ pulled and attracted the positive ions present in the methylene blue which is a cationic compound and this interaction reduced the distance of both chemicals making it possible to have a better performance due to the proximity among them. In the case of samples that contain more than 10 mg of glucose the photocatalytic activity starts to decrease until it presents a worst performance than the pure titanium dioxide. The explanation to this phenomenon is that the carbon that was supposed to act as a medium of direct transport ended up acting as a barrier impeding the molecules of dye from contacting the TiO₂.

### Photodegradation Kinetics

The reaction for the degradation of the organic contaminant chosen for the experiment followed first order of kinetics where just one of the components defines, in the slow step, the reaction rate. The formula used was the integrated first order law where, when plotted, the slope of the equation shows a tendency to increase in a linear manner that reflects the performance of the compounds. The greater the slope, the better the compound in the degradation of the methylene blue. The equation for the first order rate kinetics is shown below:

$$ln \frac{{C}_{0}}{C} = Kt$$

Cₒ represents the initial concentration of methylene blue without the addition of the TiO₂; C is the concentration at a certain given time, t. The logarithm of the ratio between Cₒ and C is proportional to K which is the slope constant of the data times and the time the experiment lasted. The time considered for the experiment was a maximum of 4 hours and limited to the amount of time that influenced the behavior of the graph. The blank solution produced was maintained constant for all the different tests so that just the effect of the compound could attributed to the total degradation of the dye.

FIG. 4 shows the performance of the 6 types of compounds synthesized by the hydrothermal process with the proportional carbon ratios. The slopes of the compounds were calculated by manipulation of the equation of the first order kinetics by solving for K, which represented the efficiency in the degradation of the methylene blue at a specific time during the experiment until reaching almost a 100 percent of disappearance of methylene blue. All samples started from a value of 1 until reaching the maximum of activity in different time periods and the magnitude of the slope was an indicator of the best working compounds for degradation of the dye. From Table 1, the sample with the best performance was the TiO₂ coated with 3 mg of glucose. This sample was followed by the TiO₂ coated with 5.00, 10.0, 20.0, 1.00, 0 and 200 milligrams of glucose in decreasing order of activity.

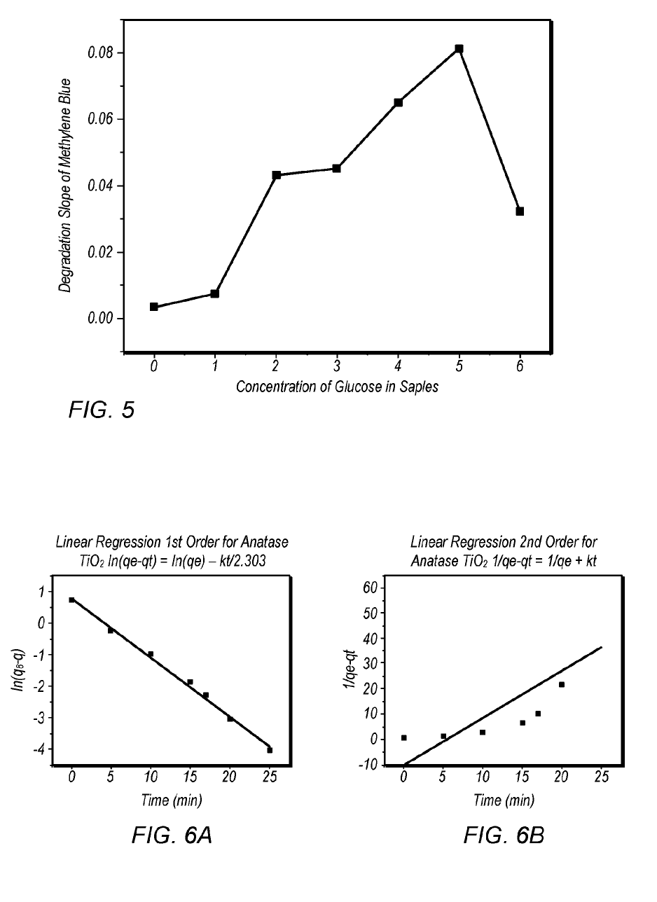

The image in FIG. 5 is just an extension of the data in FIG. 4. FIG. 5 only takes in consideration the slopes of the 6 compounds that were used over the concentration of glucose present. The numbers in the horizontal axis goes from 0 to 6 and they represent the decreasing ratio of glucose present in the titanium dioxide as follows: 0 is the control where TiO₂ contains 0 glucose; 1 represents sample 1 that contains 200 mg; sample 2 is 10.0 mg and so on until reaching number 6 that is the sample containing 1 mg of glucose. In the graph it is easier to notice that sample 5 was the best of all and therefore the one to be used for a shorter and effective decomposition of the methylene blue solution.

### Absorption Kinetics

In the graphs represented by FIG. 6, the unmodified TiO₂ nanocrystals were tested in a MB concentration of 5 ppm. The first graph (FIG. 6A) is the regression for the first order kinetics of the sample results. The second graph (FIG. 6B) shows the same phenomena and reaction but applied to the second order kinetics formula. Based in the graphical representation provided by the figures, it can be seen that the pure form of titanium dioxide follows a first pseudo order kinetics behavior rather than a second order. The linearity variable R² was calculated based on the tendency of the points to follow a consistent path for each of the graphs and these values were 0.994 and 0.6435, respectively. The closer the value of R² to the value of one the greater the reliance of data. Since the value of R² was 0.994 based on the first order kinetics, i.e. the analysis on pristine titanium dioxide was best fitted with the first order kinetics, the adsorption process is considered as physisorption.

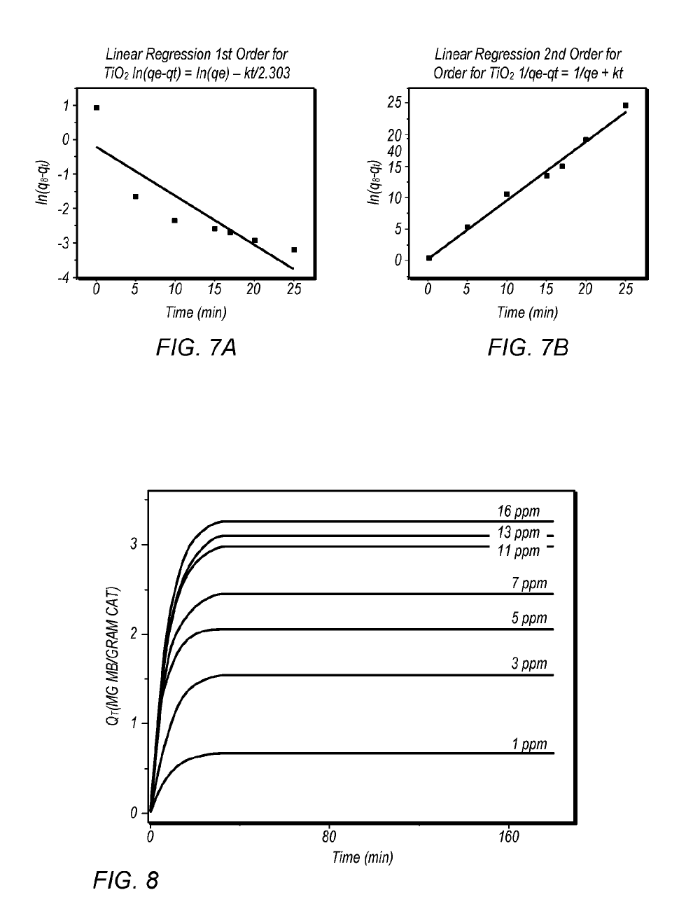

The analysis of the carbon treated nanoparticles was made in an invariable MB solution concentration (5 ppm) for consistency of results, and all the parameters and conditions were kept the same as the unmodified titanium dioxide test. The obtained numbers were plotted versus the irradiation time and the kinetics of the product was made based in the first and second order kinetics relationships The first graph (FIG. 7A) is the regression for the first order kinetics of the sample results. The second graph (FIG. 7B) shows the same phenomena and reaction but applied to the second order kinetics formula. The correlation linearity value of the line in the second order kinetics graph had a R² value of 0.98, which confirmed that the kinetic process was second order instead of a first order since the R² value based on first order kinetics was only 0.76. The second order kinetics relationship explains that an additional process rather than the physical effect had to be occurring for the faster unexpected adsorption. Chemisorption is considered for these cases due to the possible interactions and reactions between the molecules of the dye with the carbon rich catalyst.

An additional adsorption study was made in order to understand the saturation point of both unmodified TiO₂ and glucose treated TiO₂ particles and how the adsorption capacity changed depending on the concentration of the solution being tested. FIG. 8 illustrates that, as the concentration of the methylene blue increases, the adsorption of the catalyst increases. The distinction is seen from the adsorption of the catalyst product at 13 ppm compared to 1 ppm, in which the adsorption went from 0.6 to around 3.5 units. From the graph it was also determined that the saturation point at which no more pollutant was able to be adsorbed is represented by the flat line portion of the graph.

The lack of increasing absorbance after 35 minutes is due to the total covering on the surface of both unmodified TiO₂ and glucose treated TiO₂ particles. At this point, the hydroxyl and carboxylic groups reach their maximum adsorbing amount of pollutant and they are in equilibrium.

### Equilibrium Study

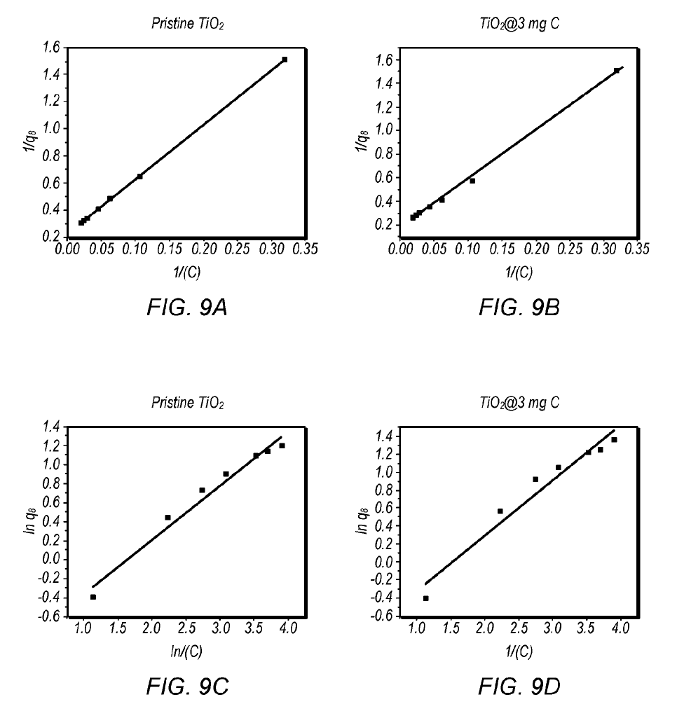

The different values of qₑ for the unmodified titanium dioxide and the coated samples were plotted into two linear forms of Langmuir and Freundlich isotherms (FIG. 9). The values for both equations were similar, but the best fit was for the Langmuir relationship that describes a monolayer in the surface of the TiO₂ anatase and in the TiO₂ coated with glucose.

### Cyclic Study

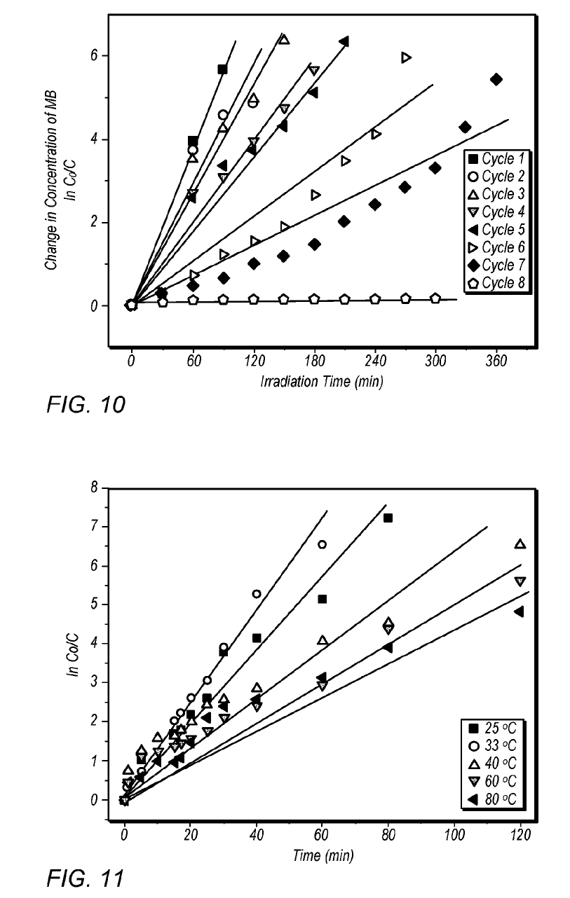

The coated nanoparticles degraded the contaminant in approximately 60 minutes for the first trial, and the time of degradation was prolonged as the number of cycles increased (FIG. 10)

The curvature of the lines that begins at cycle 6 starts to develop due to the low rate of degradation at that period of time. The straight lines that accompanies all the points is the best fitted line. At the eighth cycle there is no evident degradation; however, this is not produced due to a chemical malfunction of the product but it is accredited to a small ratio of particles in the solution. Each time a measurement was drawn from the quartz container some amount of the titanium dioxide was extracted from the solution; therefore, by the eighth cycle there was little to none of the photocatalyst in the methylene blue solution.

In order to prevent the loss of product, adequate filters must be used to collect the extracted nanoparticles in each of the trials. Based in the information provided, and in the graph in FIG. 10, the coated TiO₂ particles do not lose their ability to oxidize the pollutant, it is the absence of the product in the system that causes the decline of the efficiency.

### Thermodynamic Analysis

The temperature variation in the degradation process of MB was noticeable with the increased ratio of color disappearance and the fast decreasing absorbance values. As is shown in FIG. 11, the best temperature to perform the experiment is 33° C. followed by room temperature (25° C.). As the temperature increases over 22° C. the performance of the product starts to decrease and the time of degradation is affected negatively as well.

The decrease in the rate of reaction above certain temperature can be mainly attributed to the increased kinetic energy of the particles due to the increased temperature. Since the dye particles move faster it is difficult for them to be adsorbed by the carboxyl and hydroxyl groups on the surface of the titanium dioxide; therefore, there is a limited amount of pollutant that can be targeted at a time based on the direct contact with the photocatalyst. Even though it is normally expected that there will be an increase in degradation at higher temperatures, this specific process had the opposite effect.

From the slope shown by this analysis for the reactions at each individual temperature, the concentrations can be determined in order to obtain an equilibrium constant for each, this experimental constant would provide the information required to calculate the state of the system by the determination of the Gibbs free energy, enthalpy and entropy of the isobaric reaction.

The state of the system for the adsorption analysis was possible due to the calculation of the equilibrium constant (10). Table 2 shows the distinctive values for each of the temperatures manipulated in the experiment. As it can be appreciated from the formulas [9-12] there is a corresponding K, ΔG and ΔS value for the change in temperatures; and a single value for ΔH.

TABLE 2
Thermodynamic study of methylene blue photodegradation
by coated TiO₂ particles with 3 mg carbon

| | | Gibbs free | | |
|---|---|---|---|---|
| Temperature | Equilibrium | energy | Enthalpy | Entropy |
| (K) | Constant | (J) | (J) | (J) |
| 298 | 1.28 | −612 | −13543 | −43.4 |
| 306 | 1.65 | −1281 | −13543 | −40.1 |
| 313 | 1.18 | −425 | −13543 | −41.9 |
| 333 | 0.93 | 209 | −13543 | −41.3 |
| 353 | 0.61 | 1439 | −13543 | −42.4 |

In the thermodynamic analysis of the degradation of the methylene blue the best temperature for the reaction was calculated to be 33° C. which explains the greater value of K when compared to the other temperatures. After the 33° C. the equilibrium constant for the other trials start to decrease which dramatically affects the value of ΔG. Based on Table 2, the reaction is spontaneous only if the temperature is below 40° C., but if this temperature is surpassed, the Gibbs free energy acquires a positive sign which represents the non-spontaneity of the experiment.

The enthalpy of the reaction (ΔH) was calculated with the incorporation of each of the equilibrium constants over the inverse of the temperature. A straight line was produced from the relationship and after the proper manipulation of the formula the value −13,543 J mol⁻¹ stated that the system caused an exothermic reaction.

### CONCLUSION

TiO₂ samples coated with carbon by a hydrothermal process have a better effect on the decomposition of the dye methylene blue in aqueous solution than unmodified TiO₂ anatase. Coated TiO₂ formed from a composition that includes 3 mg of glucose achieved the fastest degradation of methylene blue (complete in about 60 minutes). The degradation reactions of coated TiO₂ followed first order rate kinetics for the photocatalytic activation part and for the kinetics adsorption experiment. The results showed that the unmodified TiO₂ anatase followed pseudo first order kinetics promoting a physical adsorption while the TiO₂ coated with 3 mg of glucose followed the pseudo second order kinetics demonstrating chemisorption. The equilibrium test on the samples follows Langmuir's model for the uncoated and the carbon coated TiO₂ nanoparticles which confirmed a monolayer formation of MB on the surface of the products before the degradation of the pollutant. The best temperature to carry out the photodegradation process was documented to be 33° C. For the adsorption process the reaction results show variability with temperature but at a steady room temperature the reaction is spontaneous and exothermic.

In this patent, certain U.S. patents, U.S. patent applications, and other materials (e.g., articles) have been incorporated by reference. The text of such U.S. patents, U.S. patent applications, and other materials is, however, only incorporated by reference to the extent that no conflict exists between such text and the other statements and drawings set forth herein. In the event of such conflict, then any such conflicting text in such incorporated by reference U.S. patents, U.S. patent applications, and other materials is specifically not incorporated by reference in this patent.

Further modifications and alternative embodiments of various aspects of the invention will be apparent to those skilled in the art in view of this description. Accordingly, this description is to be construed as illustrative only and is for the purpose of teaching those skilled in the art the general manner of carrying out the invention. It is to be understood that the forms of the invention shown and described herein are to be taken as examples of embodiments. Elements and materials may be substituted for those illustrated and described herein, parts and processes may be reversed, and certain features of the invention may be utilized independently, all as would be apparent to one skilled in the art after having the benefit of this description of the invention. Changes may be made in the elements described herein without departing from the spirit and scope of the invention as described in the following claims.

1. A photocatalyst particle comprising:
a transition metal oxide or transition metal sulfide core; and
an adsorbent layer at least partially surrounding the transition metal oxide core;
wherein the adsorbent layer is capable of adsorbing pollutants and microorganisms in a wastewater stream.

2. The photocatalyst particle of claim 1, wherein the adsorbent layer is a carbonaceous coating layer.

3. The photocatalyst particle of claim 1, wherein the adsorbent layer has a thickness of less than 1 micron.

4. The photocatalyst particle of claim 1, wherein the core is a transition metal oxide.

5. The photocatalyst particle of claim 1, wherein the core is a transition metal sulfide.

6. The photocatalyst particle of claim 1, wherein the transition metal of the core is selected from the group consisting of Ti, W, Fe, Zn, Cd, Sr, and Sn.

7. The photocatalyst particle of claim 1, wherein the core comprises titanium dioxide, SrTiO₃, or their derivatives.

8. A method of making a photocatalyst particle, comprising:
obtaining a core particle, the core particle comprising a transition metal oxide or transition metal sulfide; and
forming a carbonaceous coating on the core particle.

10. The method of claim 9, wherein the core particle has a diameter of less than about 1 micron.

11. The method of claim 9, wherein the carbonaceous coating has a thickness of less than 1 micron.

12. The method of claim 9, wherein forming a carbonaceous coating on the core particle comprises placing uncoated core particles in water and reacting the core particle with a carbohydrate at a temperature of less than 200° C. and greater than 100° C.

13. The method of claim 9, wherein forming a carbonaceous coating on the core particle comprises placing uncoated core particles in water and reacting the core particle with a carbohydrate at a temperature greater than 100° C. and a pressure of greater than 1 atm.

14. The method of claim 9, wherein the core particle is a transition metal oxide.

15. The method of claim 9, wherein the core particle is a transition metal sulfide.

16. The method of claim 9, wherein the transition metal of the core is selected from the group consisting of Ti, W, Fe, Zn, Cd, and Sn.

17. The method of claim 9, wherein the core comprises titanium dioxide, SrTiO₃, or their derivatives.

18. A method of decontaminating a polluted wastewater stream comprising:
contacting the wastewater stream with a photocatalyst particle as described in claim 1 for a time sufficient to remove or destroy at least about 90% of the contaminants in the wastewater stream.
